(19) United States
(12) Patent Application Publication
(10) Pub. No.: US 2026/0283116 A1
(43) Pub. Date: Sep. 24, 2026

(54) TRAINING COLLAR FOR ANIMALS HAVING AN ELASTIC FIXING ELEMENT AND ASSOCIATED USE

(71) Applicant: Herm. Sprenger GmbH & Co. KG, Iserlohn (DE)

(72) Inventor: Martin SPRENGER, Iserlohn (DE)

(73) Assignee: Herm. Sprenger GmbH & Co. KG, Iserlohn (DE)

(21) Appl. No.: 19/573,117

(22) Filed: Mar. 20, 2026

(30) Foreign Application Priority Data
Mar. 21, 2025 (DE) 102025111121.9

(51) Int. Cl. A01K 27/00; A01K 15/02

(52) U.S. Cl. CPC A01K 27/001; A01K 15/02

(57) ABSTRACT

A training collar for animals comprising a collar section and either a slip loop connecting the two ends of the collar section or a closure element connecting the two ends, and wherein the training collar includes at least one elastic fixing element. The elastic fixing element forms a flat abutment element and a plurality of regularly spaced, mushroom shaped projections which are rooted in a main surface of the abutment element. The collar section is composed of a plurality of chain links hooked together in succession, a majority of which are each configured as mutually uniform wire bending elements. Each wire bending element has a base body extending in the circumferential direction of the collar section and two arms projecting radially inward. The arms of one wire bending element hook with two engagement regions of the base body of a next wire bending element.

The disclosure relates to a training collar for animals, for example dogs, comprising a collar section and a slip loop, in which the collar section is composed of a plurality of uniform chain links, each configured as a wire bending element and hooked together in succession, as well as to an associated use. The wire bending element of this plurality of uniform chain links in each case has a base body that extends in the circumferential direction, preferably lying substantially in a first plane, and two arms which project radially inward, and thus toward the animal's neck, from the base body. The arms of a wire bending element are configured to hook with two engagement regions of a next chain link, in particular a wire bending element, each engagement region being assigned to a respective arm. Although this hooking has the advantage that the collar section can be readily adapted to the animal's neck circumference by adding and removing individual chain links, stabilization of the collar section in the applied state, during application, and in particular after removal of the collar section and during storage of the unused collar section, is lacking. Without additional stabilization, the collar section sags loosely, the chain links hook into one another, or individual chain links may even become unhooked. If the chain links are not in their intended hooked state, application of the collar section is impeded.

In a factory-new, unused training collar, the spreading of the arms that counteracts unhooking and is thus necessary is present; however, in used training collars there is an increasing tendency for the relative distance between the two arms to change, with the consequence that unhooking is significantly facilitated. This can lead to unintended tearing loose of the animal and must not occur in practice.

Furthermore, there is a need to protect the training collar, in the applied state, from the ingress of foreign objects such as branches, in particular when rummaging through undergrowth. In addition, conventional training collars lack the possibility of individualization by attachment of markings such as lettering, so that assignment to a specific animal can be visually indicated. It is furthermore desirable that the stabilization can be removed without destruction and without tools, in order to preserve the tool-free adjustability of the training collar by removing individual chain links or by lengthening by means of further chain links.

Proceeding from this, the disclosure is based on the object of further developing the training collar of the type mentioned at the outset, in particular to counteract unintended unhooking of the chain links; in particular to bring about stabilization of the chain links to facilitate storage and application; to provide foreign-object protection; to enable tool-free, non-destructive removal of the stabilization; and to facilitate the application of an individualizing marking.

This object is achieved by a training collar according to claim 1. An equally advantageous use is the subject of the independent claim. Advantageous embodiments can be taken from the dependent claims. It is pointed out that the features listed individually in the patent claims can be combined with one another in any technologically sensible manner and show further embodiments of the disclosure. The description, in particular in conjunction with the figures, further characterizes and specifies the disclosure.

The disclosure relates to a training collar for animals, in particular dogs, comprising a collar section and a slip loop connecting the two ends of the collar section, and at least one elastic fixing element. In place of the slip loop, a closure element connecting the two ends of the collar section is provided.

According to the disclosure, the elastic fixing element forms a flat abutment element and a plurality of regularly spaced, mushroom-shaped projections which are rooted in a main surface of the abutment element. Preferably, the abutment element and the mushroom-shaped projections of the elastic fixing element are formed in one piece. Preferably, the fixing element is made of an elastomer, preferably a silicone elastomer. The slip loop is, for example, configured as a slip chain formed from multiple metallic chain links, which is guided through eyelets at the ends of the collar. In another embodiment, it is essentially a fabric-sheathed nylon cord or the like. The term “loop” is not intended to exclude the provision of a closure or the like.

According to the disclosure, the collar section is composed of a plurality of chain links hooked together in succession, a majority of which are each configured as mutually uniform wire bending elements.

The wire bending element of this plurality of uniform chain links in each case has a base body which extends in the circumferential direction, preferably lying substantially in a first plane, and two arms projecting radially inward, and thus toward the animal's neck, from the base body. Here, “circumferential direction” is not to be construed narrowly, and includes, inter alia, a tangential extension as well as an extension following the neck circumference in parallel. For example, these arms are arranged in a common second plane, wherein the first plane encloses an acute angle with the second plane. For example, the arms enclose an angle of 30° to 40° with the first plane. The arms may be cranked once or multiple times. The arms of a wire bending element are designed to hook with two engagement regions of a next wire bending element, each engagement region being assigned to one arm. Preferably, the arms spread toward their free ends, in order to prevent unhooking.

According to the disclosure, the engagement regions of the next wire bending element are separated by an inwardly directed, U-shaped wire bow, which in each case forms a receptacle. Each such receptacle is penetrated by one of the mushroom-shaped projections of the elastic fixing element with the main surface of the abutment element bearing against the side of the base body facing away from the arms, i.e. the radially outer side. In doing so, a mushroom-headed free end of the projection engages behind the U-shaped wire bow forming the receptacle. In this way, the fixing element is secured on the collar section in a tool-free and non-destructive yet releasable manner, and the adaptability of the training collar to different neck cross-sections is maintained by removing individual chain links or by lengthening by means of additional chain links. The fixing element furthermore provides stabilization of the collar section in the applied state, during application and in particular after removal of the collar section and during storage of the unused collar section. The collar section does not sag loosely in the unused state, and the chain links do not hook into one another. Unhooking of individual chain links is completely avoided. Furthermore, in the applied state, the training collar is protected by the fixing element from ingress of foreign objects such as branches, in particular when moving through underbrush. The inventive training collar offers the possibility of individualization by applying markings such as lettering to the fixing element, in particular to the main surface of the fixing element facing away from the collar section, for example to visually signal assignment to a specific animal.

Preferably, the fixing element furthermore forms a pair of two counter-oriented hooks which grip around the base body. In one embodiment, the free ends of the pair of counter-oriented hooks face one another. In another embodiment, the free ends of the pair of counter-oriented hooks point away from one another in opposite directions. In the latter embodiment, for example, the free ends are brought together in a common pedestal which itself is rooted in the flat abutment element, resulting in a T-shaped cross-section, or the hooks of a pair are each supported on the abutment element via a supporting web. For example, the number of pairs corresponds to the number of chain links, in particular wire bending elements, covered by the fixing element. Preferably, each hook of the pair grips a leg of the base body that transitions into the arm.

Preferably, the elastic fixing element forms three or more mushroom-shaped projections. For example, the number of mushroom-shaped projections is at least equal to the number of wire bending elements covered by the fixing element.

Preferably, the collar section comprises at least one intermediate link and two end links as chain links. The end links are provided, for example, to form an eyelet for guiding the slip loop or for connection to the closure element. The at least one intermediate link serves, for example, to connect two segments of the collar section composed of multiple uniform wire bending elements hooked in succession with opposite run directions of their wire bending elements, the intermediate link also being designated as a center link. In another embodiment, the collar section has two end links and two intermediate links, the latter to secure exactly one segment of multiple wire bending elements hooked in succession in one run direction to the end links via the intermediate links and to form the transition of this segment to one of the end links. The fixing element furthermore has at least one further mushroom-shaped projection for securing the fixing element on the intermediate link and/or end link. The further mushroom-shaped projection, for example, penetrates an opening in the end link, which also serves to guide or hook one of the intermediate links to the end link. This further mushroom-shaped projection is, for example, T-shaped and is rooted on an imaginary line on which the mushroom-shaped projections are rooted in the main surface of the abutment element facing the collar section. The end links are likewise, for example, bent from wire or preferably formed as a stamped sheet-metal part. The intermediate link is likewise, for example, bent from wire or preferably formed as a stamped sheet-metal part.

Preferably, one of the intermediate links and/or end links is configured as a closure. For example, the intermediate link designated as the center link is configured as a closure.

Preferably, multiple fixing elements are secured on the collar section. For example, these fixing elements extend from the respective end link over chain links following in the circumferential direction of the collar section up to an intermediate link. Preferably, the two fixing elements differ in their number of mushroom-shaped projections.

The disclosure also relates to the use of the training collar in any of the embodiments described above for dog training.

The disclosure permits further particularly advantageous embodiments, some of which are the subject of the dependent claims and are explained below with reference to the exemplary embodiments of the disclosure shown in the accompanying drawings. Shown are:

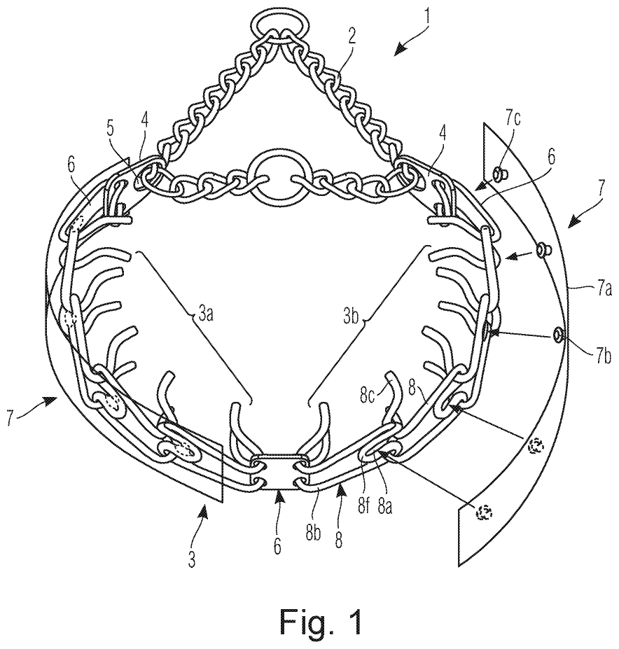

FIG. 1: a plan view of an inventive training collar (1) in a first embodiment with two fixing elements (7);

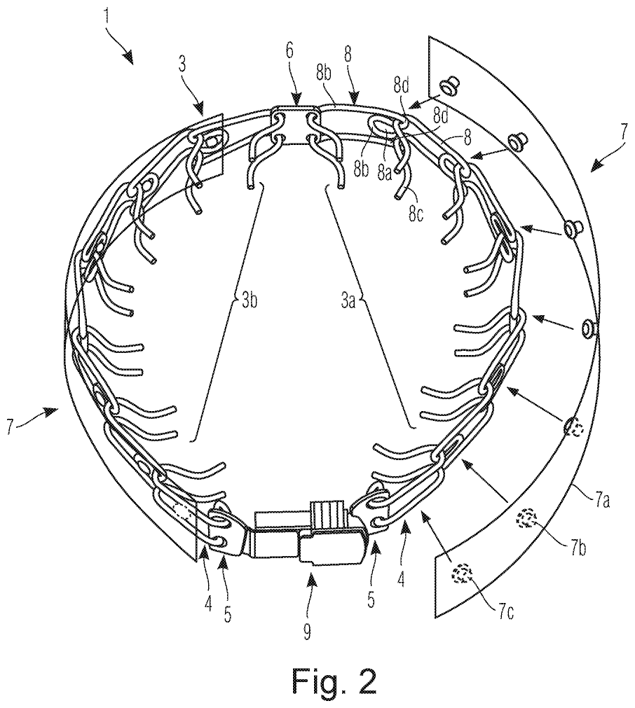

FIG. 2: a plan view of an inventive training collar (1) in a second embodiment with two fixing elements (7);

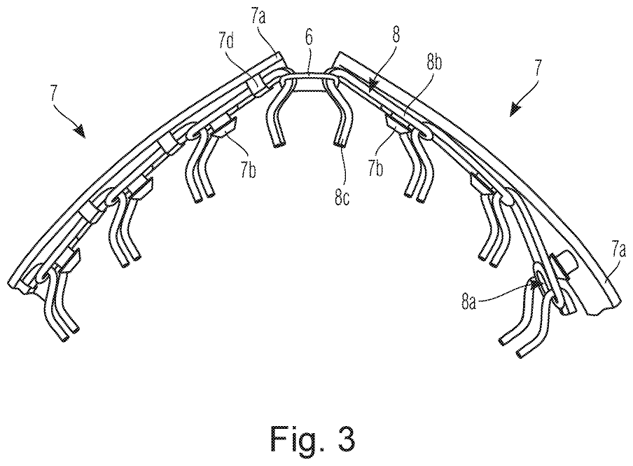

FIG. 3: a detail view of an inventive training collar (1) with two fixing elements (7) in a first or second embodiment;

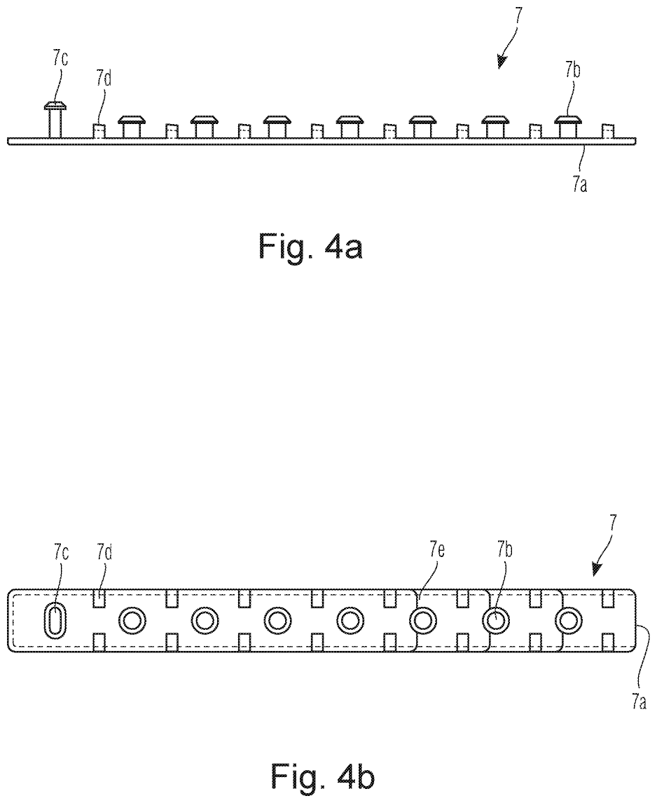

FIG. 4a: a side view of the fixing element (7) belonging to the inventive training collar (1) in a second embodiment;

FIG. 4b: a rear view of the fixing element (7) of the second embodiment shown in FIG. 4a;

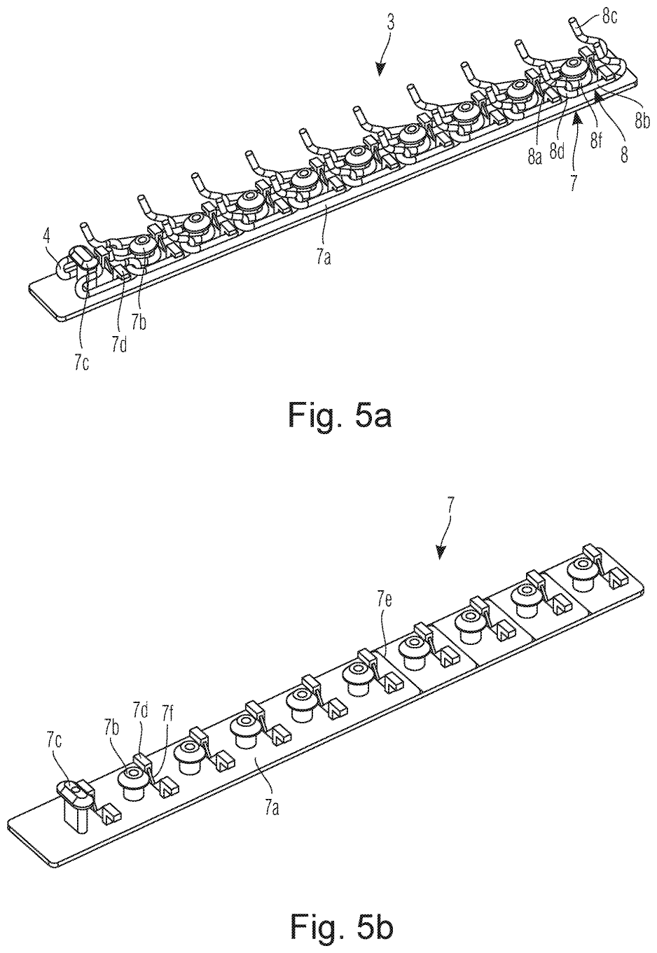

FIG. 5a: a perspective view of a collar section (3) of the training collar with a fixing element (7) secured thereto in a third embodiment;

FIG. 5b: the fixing element (7) of the third embodiment in perspective view.

The disclosure relates, as shown in FIG. 1, to a training collar (1), in particular for dogs, in a first embodiment having a collar section (3) and a slip loop (2) connecting two ends (5) of the collar section (3), and two elastic fixing elements (7). The collar section (3) comprises three intermediate links (6) and two end links (4) as chain links (4, 6, 8), the end links (4) in each case forming the eyelet for guiding the slip loop (2) which forms a closed loop. The lower intermediate link (6) in FIG. 1 serves to connect two segments (3a, 3b) of the collar section (3), which are composed of multiple uniform chain links (4, 6, 8) hooked together in succession, each formed and designated as a wire bending element (8), with opposite run directions of their wire bending elements (8). In addition, the collar section (3) has two further intermediate links (6) hooked with the end links (4), the latter to secure in each case exactly one segment (3a, 3b) of multiple wire bending elements (8) hooked together in succession in one run direction to the end links (4) via the intermediate links (6) and to form the transition of this segment (3a, 3b) to one of the end links (4). The end links (4) and one of the intermediate links (6) are formed as stamped sheet-metal parts. The respective intermediate links (6) directly connected with the end link (4), shown at the top in FIG. 1, are bent from wire.

The elastic fixing element (7) in each case has a flat, plate-shaped abutment element (7a) and multiple regularly spaced, mushroom-shaped projections (7b) which are rooted in a main surface of the abutment element (7a) of the fixing element (7). The abutment element (7a) and the mushroom-headed projections (7b) of the elastic fixing element (7) are formed in one piece. The fixing element (7) is made of an elastomer, in particular a silicone elastomer, and is therefore flexible and can be shortened by cutting to a desired length or dimension. The collar section (3) is composed of a plurality of chain links (4, 6, 8) hooked together in succession, the majority of which are each formed as mutually uniform wire bending elements (8).

The wire bending element (8) of this plurality of uniform chain links (4, 6, 8) in each case has a base body (8b) extending in the circumferential direction, preferably lying substantially in a first plane, and two arms (8c) which project radially inward, and thus toward the animal's neck, from the base body (8b) of the wire bending element (8). Typically, these arms (8c) of a wire bending element (8) are arranged in a common second plane, the first plane enclosing an acute angle with the second plane. For example, the arms (8c) enclose an angle of 30° to 40° with the first plane. The arms (8c) may be cranked once or, as shown, multiple times. The arms (8c) of a wire bending element (8) are designed to hook with two engagement regions (8d) of a next wire bending element (8), each engagement region (8d) being assigned to a respective arm (8c). As shown, the arms (8c) spread toward their free ends to prevent unhooking.

According to the disclosure, the engagement regions (8d) of the next wire bending element (8) are separated by an inwardly directed, U-shaped wire bow (8f), which in each case forms a receptacle (8a). Each receptacle (8a) is penetrated by one of the mushroom-shaped projections (7b) of the elastic fixing element (7) with the main surface of the abutment element (7a) bearing against the side of the base body (8b) facing away from the arms (8c), i.e. the radially outer side. As shown in FIG. 2, a mushroom-headed free end of the mushroom-shaped projection (7b) engages behind the U-shaped wire bow (8f) forming the receptacle (8a). In this manner, the fixing element (7) is secured on the collar section (3) in a tool-free and non-destructive yet releasable manner, and the adaptability of the training collar (1) to different neck cross-sections is maintained by removing individual chain links (4, 6, 8) or by lengthening by means of further chain links (4, 6, 8). The fixing element (7) furthermore provides stabilization of the collar section (3) in the applied state, during application, and in particular after removal of the collar section (3) and during storage of the unused collar section (3). The collar section (3) does not sag loosely in the unused state; the chain links (4, 6, 8) do not hook into one another. Unintended unhooking of individual chain links (4, 6, 8) is completely avoided. Furthermore, in the applied state, the training collar (1) is protected by the fixing element (7) from the ingress of foreign objects such as branches, in particular when moving through underbrush. The training collar (1) offers the possibility of individualization by applying markings such as lettering or symbols to the fixing element, in particular to the main surface of the fixing element facing away from the collar section (3), for example to visually signal assignment to a specific dog.

As shown in FIGS. 3, 4a and 4b, the fixing element may additionally have a pair of two counter-oriented hooks (7d) that grip around the base body (8b) of the wire bending element (8). The free ends of the hooks (7d) of the pair point toward one another. The number of pairs of hooks (7d) corresponds to the number of wire bending elements (8) covered by the fixing element among the plurality of uniform chain links (4, 6, 8). Preferably, each hook (7d) of the pair captures a leg of the respective base body (8b) that transitions into the arm (8c).

In the embodiments shown, the elastic fixing element (7) forms three or more mushroom-shaped projections (7b). Thus, the number of mushroom-shaped projections (7b) is at least equal to the number of wire bending elements (8) covered by the fixing element (7b) among the plurality of uniform chain links (4, 6, 8).

As can be seen in FIG. 1 and FIG. 4a/4b, the fixing element (7) further has at least one additional mushroom-shaped projection (7c) to secure the fixing element (7) on the intermediate link (6) and the end link (4). The further mushroom-shaped projection (7c) penetrates an opening in the end link (4), which also serves to guide or hook an associated intermediate link (6) to the end link (4). This further mushroom-shaped projection (7c) is T-shaped in cross-section and is arranged on a common imaginary line on which the mushroom-shaped projections (7b) are also rooted.

FIG. 2 shows a training collar (1), in particular for dogs, in a second embodiment with a collar section (3) and a closure element (9) connecting the two ends (5) of the collar section (3), and two elastic fixing elements (7). The collar section (3) comprises one intermediate link (6) and two end links (4) as chain links (4, 6, 8), the end links (4) in each case serving for hooking with the closure element (9). The upper intermediate link (6) in FIG. 2 serves to connect two segments (3a, 3b) of the collar section (3), which are composed of multiple uniform chain links (4, 6, 8) hooked together in succession, each formed and designated as a wire bending element (8), with opposite run directions of their wire bending elements (8). The end links (4) are bent from wire, while the intermediate link (6) is formed as a stamped sheet-metal part.

The elastic fixing element (7) in each case has a flat, plate-shaped abutment element (7a) and multiple regularly spaced, mushroom-shaped projections (7b) which are rooted in a main surface of the abutment element (7a) of the fixing element (7). The abutment element (7a) and the mushroom-headed projections (7b) of the elastic fixing element (7) are formed in one piece. The fixing element (7) is made of an elastomer, in particular a silicone elastomer, and is therefore flexible and can be shortened by cutting to a desired length or dimension. For this purpose, the abutment element (7a) of the fixing element (7) has transversely extending pre-scorings (7e). The collar section (3) of this second embodiment is likewise composed of a plurality of chain links (4, 6, 8) hooked together in succession, the majority of which are each formed as mutually uniform wire bending elements (8).

The wire bending element (8) of this plurality of uniform chain links (4, 6, 8) in each case has a base body (8b) extending in the circumferential direction, preferably lying substantially in a first plane, and two arms (8c) which project radially inward, and thus toward the animal's neck, from the base body (8b) of the wire bending element (8). Typically, these arms (8c) of a wire bending element (8) are arranged in a common second plane, the first plane enclosing an acute angle with the second plane. For example, the arms (8c) enclose an angle of 30° to 40° with the first plane. The arms (8c) may be cranked once or, as shown, multiple times. The arms (8c) of a wire bending element (8) are designed to hook with two engagement regions (8d) of a next wire bending element (8), each engagement region (8d) being assigned to a respective arm (8c). As shown, the arms (8c) spread toward their free ends to prevent unhooking.

According to the disclosure, the engagement regions (8d) of the next wire bending element (8) are separated by an inwardly directed, U-shaped wire bow (8f), which in each case forms a receptacle (8a). Each receptacle (8a) is penetrated by one of the mushroom-shaped projections (7b) of the elastic fixing element (7) with the main surface of the abutment element (7a) bearing against the side of the base body (8b) facing away from the arms (8c), i.e. the radially outer side. As shown in FIG. 2, a mushroom-headed free end of the mushroom-shaped projection (7b) engages behind the U-shaped wire bow (8f) forming the receptacle (8a). In this manner, the fixing element (7) is secured on the collar section (3) in a tool-free and non-destructive yet releasable manner, and the adaptability of the training collar (1) to different neck cross-sections is maintained by removing individual chain links (4, 6, 8) or by lengthening by means of further chain links (4, 6, 8). The fixing element (7) furthermore provides stabilization of the collar section (3) in the applied state, during application, and in particular after removal of the collar section (3) and during storage of the unused collar section (3). The collar section (3) does not sag loosely in the unused state; the chain links (4, 6, 8) do not hook into one another. Unintended unhooking of individual chain links (4, 6, 8) is completely avoided. Furthermore, in the applied state, the training collar (1) is protected by the fixing element (7) from the ingress of foreign objects such as branches, in particular when moving through underbrush. The training collar (1) offers the possibility of individualization by applying markings such as lettering or symbols to the fixing element, in particular to the main surface of the fixing element facing away from the collar section (3), for example to visually signal assignment to a specific dog.

As shown in FIGS. 3, 4a and 4b, the fixing element may additionally have a pair of two counter-oriented hooks (7d) that grip around the base body (8b) of the wire bending element (8). The free ends of the hooks (7d) of the pair point toward one another. The number of pairs of hooks (7d) corresponds to the number of wire bending elements (8) covered by the fixing element among the plurality of uniform chain links (4, 6, 8). Preferably, each hook (7d) of the pair captures a leg of the respective base body (8b) that transitions into the arm (8c).

In the embodiments shown, the elastic fixing element (7) forms three or more mushroom-shaped projections (7b). Thus, the number of mushroom-shaped projections (7b) is at least equal to the number of wire bending elements (8) covered by the fixing element (7b) among the plurality of uniform chain links (4, 6, 8).

As can be seen in FIGS. 2 and 4a/4b, the fixing element (7) further has at least one additional mushroom-shaped projection (7c) for securing the fixing element (7) on the intermediate link (6) and the end link (4). The further mushroom-shaped projection (7c) penetrates the clear gap remaining between the wire legs of the end link (4), in order to pass through the wire legs of the end link (4) and to engage behind a wire loop provided for locking. This further mushroom-shaped projection (7c) is T-shaped in cross-section and is arranged on a common imaginary line extending in the longitudinal direction of the abutment element (7a) of the fixing element (7), on which the mushroom-shaped projections (7b) are likewise rooted. The further mushroom-shaped projection (7c) has a greater height above the abutment element (7a) than the mushroom-shaped projection (7b).

FIG. 4a shows a training collar, in particular for dogs, in a third embodiment with a section of the collar section (3) and an elastic fixing element (7). The shown section of the collar section (3) comprises an end link (4) and a plurality of uniform chain links (4, 8) formed as wire bending elements (8), the end link (4) serving for hooking with the (not shown) closure element (9). The end link (4) is likewise bent from wire.

The elastic fixing element (7) in each case has a flat, plate-shaped abutment element (7a) and multiple regularly spaced, mushroom-shaped projections (7b) which are rooted in a main surface of the abutment element (7a) of the fixing element (7). The abutment element (7a) and the mushroom-headed projections (7b) of the elastic fixing element (7) are formed in one piece. The fixing element (7) is made of an elastomer, in particular a silicone elastomer, and is therefore flexible and can be shortened by cutting to a desired length or dimension. For this purpose, the abutment element (7a) of the fixing element (7) has transversely extending pre-scorings (7e).

The wire bending element (8) of this plurality of uniform chain links (4, 6, 8) in each case has a base body (8b) extending in the circumferential direction, preferably lying substantially in a first plane, and two arms (8c) which project radially inward, and thus toward the animal's neck, from the base body (8b) of the wire bending element (8). Typically, these arms (8c) of a wire bending element (8) are arranged in a common second plane, the first plane enclosing an acute angle with the second plane. For example, the arms (8c) enclose an angle of 30° to 40° with the first plane. The arms (8c) may be cranked once or, as shown, multiple times. The arms (8c) of a wire bending element (8) are designed to hook with two engagement regions (8d) of a next wire bending element (8), each engagement region (8d) being assigned to a respective arm (8c). As shown, the arms (8c) spread toward their free ends to prevent unhooking.

According to the disclosure, the engagement regions (8d) of the next wire bending element (8) are separated by an inwardly directed, U-shaped wire bow (8f) which in each case forms a receptacle (8a). Each receptacle (8a) is penetrated by one of the mushroom-shaped projections (7b) of the elastic fixing element (7) with the main surface of the abutment element (7a) bearing against the side of the base body (8b) facing away from the arms (8c), i.e. the radially outer side. As shown in FIG. 4a, a mushroom-headed free end of the mushroom-shaped projection (7b) engages behind the U-shaped wire bow (8f) forming the receptacle (8a). In this manner, the fixing element (7) is secured on the collar section (3) in a tool-free and non-destructive yet releasable manner, and the adaptability of the training collar (1) to different neck cross-sections is maintained by removing individual wire bending elements (8) or by lengthening by means of further wire bending elements (8). The fixing element (7) furthermore provides stabilization of the collar section (3) in the applied state, during application, and in particular after removal of the collar section (3) and during storage of the unused collar section (3). The collar section (3) does not sag loosely in the unused state; the wire bending elements (8) do not hook into one another. Unintended unhooking of individual chain links (4, 6, 8) is completely avoided. Furthermore, in the applied state, the training collar (1) is protected by the fixing element (7) from the ingress of foreign objects such as branches, in particular when moving through underbrush. The training collar (1) offers the possibility of individualization by applying markings such as lettering or symbols to the fixing element, in particular to the main surface of the fixing element facing away from the collar section (3), for example to visually signal assignment to a specific dog.

As shown in FIGS. 5a and 5b, the fixing element (7) of the third embodiment additionally has a pair of two counter-oriented hooks (7d) which grip around the base body (8b) of the wire bending element (8), the free ends in the embodiment shown here pointing away from one another. In addition, the hooks (7d) are supported by a supporting web (7f) rooted in the abutment element (7a) of the fixing element (7). The number of pairs of hooks (7d) corresponds to the number of wire bending elements (8) covered by the fixing element (7). In this case, each hook (7d) of the pair captures a leg of the respective base body (8b) that transitions into the arm (8c).

In the embodiments shown, the elastic fixing element (7) forms multiple mushroom-shaped projections (7b). Thus, the number of mushroom-shaped projections (7b) is at least equal to the number of wire bending elements (8) covered by the fixing element (7b) among the plurality of uniform chain links (4, 6, 8). As can be seen in FIGS. 5a and 5b, the fixing element (7) further has at least one additional mushroom-shaped projection (7c) for securing the fixing element (7) on the end link (4). The further mushroom-shaped projection (7c) penetrates the clear gap remaining between the wire legs of the end link (4), in order to pass through the wire legs of the end link (4) and to engage behind a loop provided by it for locking. This further mushroom-shaped projection (7c) is T-shaped in cross-section and is arranged on a common imaginary line extending in the longitudinal direction of the fixing element (7), on which the mushroom-shaped projections (7b) are rooted. The further mushroom-shaped projection (7c) has a greater height above the abutment element (7a) than the mushroom-shaped projection (7b).

1. A training collar for an animal, comprising:
a collar section;
a slip loop or a closure element connecting two ends of the collar section; and
at least one elastic fixing element,
wherein the at least one elastic fixing element comprises:
a flat abutment element; and
a plurality of regularly spaced, mushroom-shaped projections
extending from a main surface of the abutment element,
wherein the collar section comprises a plurality of chain links hooked together in succession, including a plurality of uniform wire-bending elements, each wire-bending element comprising:
a base body extending in a circumferential direction of the collar section; and
two arms projecting radially inward,
wherein the arms of one wire-bending element are configured to hook into two engagement regions of a subsequent wire-bending element , the engagement regions being separated by an inwardly directed, U-shaped wire bow defining a receptacle,
wherein each receptacle receives one of the mushroom-shaped projections, such that:
the main surface of the abutment element bears against a radially outer side of the base body, and
a mushroom head of the projection engages behind the U-shaped wire bow, thereby securing the fixing element to the collar section in a tool-free and non-destructive yet releasable manner.

2. The training collar of claim 1, wherein the fixing element further comprises at least one pair of oppositely oriented hooks configured to engage around the base body of a wire-bending element.

3. The training collar of claim 2, wherein each hook engages a leg of the base body that transitions into one of the arms.

4. The training collar of claim 1, wherein the elastic fixing element comprises three or more of the mushroom-shaped projections.

5. The training collar of claim 1, wherein the abutment element and the mushroom-shaped projections are integrally formed as a one-piece elastomeric component.

6. The training collar of claim 1, wherein the collar section further comprises at least one intermediate link and/or at least two end links, and wherein the fixing element further comprises an additional mushroom-shaped projection configured to secure the fixing element to the intermediate link and/or the end link .

7. The training collar of claim 6, wherein one of the intermediate links or end links is configured as a closure element.

8. The training collar of claim 1, wherein the fixing element is made of an elastomer.

9. The training collar of claim 1, wherein a plurality of fixing elements are mounted on the collar section.

10. The training collar of claim 9, wherein two fixing elements differ in the number of mushroom-shaped projections.

11. (canceled)

12. The training collar of claim 1, wherein the animal is a dog.

13. The training collar of claim 1, wherein the fixing element is made of a silicone elastomer.
